(19) United States
(12) Patent Application Publication
(10) Pub. No.: US 2017/0312657 A1
(43) Pub. Date: Nov. 2, 2017

(54) DEFOAMING AGENT

(71) Applicants: SAN NOPCO LTD., Kyoto-shi, Kyoto (JP); KYOTO UNIVERSITY, Kyoto-shi, Kyoto (JP)

(72) Inventors: Katsuomi Shimabayashi, Kyoto-shi (JP); Hidetaka Hario, Kyoto-shi (JP); Toyoshi Shimada, Kizugawa-shi (JP); Kazuki Nakanishi, Kyoto-shi (JP)

(73) Assignees: SAN NOPCO LTD., Kyoto-shi, Kyoto (JP); KYOTO UNIVERSITY, Kyoto-shi, Kyoto (JP)

(21) Appl. No.: 15/525,205

(22) PCT Filed: Nov. 19, 2015
(86) PCT No.: PCT/JP2015/082483

§ 371 Date: May 8, 2017

(30) Foreign Application Priority Data
Nov. 22, 2014 (JP) 2014-237215

(51) Int. Cl. B01D 19/04; D21H 17/00; D21C 11/00; D21C 3/28; C08C 1/04; D21H 21/12; B01D 3/34

(52) U.S. Cl. CPC B01D 19/0409; D21H 21/12; D21H 17/74; B01D 3/34; D21C 3/28; C08C 1/04; D21C 11/0085

(57) ABSTRACT

There is provided a defoaming agent having excellent defoaming persistence. The defoaming agent includes; hydrophobic silica having a hydrophobicity (M_{X}) of 50 to 85, and a rate of change (M_{Y}/M_{X}) of a hydrophobicity (M_{Y}) after immersion for 1 hour in a methanol/ion-exchange aqueous solution (volume ratio of 80/20) of sodium hydroxide with a pH of 13 at 25° C. to the hydrophobicity (M_{X}) of 0.8 to 1.0; and at least one kind of liquid selected from the group consisting of a hydrocarbon oil, a non-reactive silicone oil and a polyoxyalkylene compound.

### TECHNICAL FIELD

The present invention relates to defoaming agent.

### BACKGROUND ART

Conventionally, there is known “a defoaming composition that is free of hydrophobizing catalyst residue and consisting essentially of an inert, hydrophobic, liquid carrier having dispersed therein hydrophobic silica particles made by a process comprising the step of contacting hydrophilic silica particles in the absence of a catalyst with silicone oil in said carrier under vacuum and at a temperature within the range from about 100 to 140° C. for a time of less than four hours” (Patent Document 1).

### CITATION LIST

### Patent Document

Patent Document 1—JP-T-2003-52B816 (corresponding international publication WO 00/58213)

### SUMMARY OF INVENTION

### Problems to be Solved by the Invention

However, the defoaming composition as described in Patent Document 1 has a problem that defoaming properties do not persist for a long period. That is, an object of the present invention is to provide a defoaming agent having excellent defoaming persistence.

The present inventors have intensively studied to attain the above object, and consequently achieved the present invention. More specifically, a gist of a feature of a defoaming agent according to the present invention lies in that the defoaming agent comprises:

hydrophobic silica (A) having a hydrophobicity [M value (M_{X})] of 50 to 85, and a rate of change (M_{Y}/M_{X}) of a hydrophobicity [M value (M_{Y})] after immersion for 1 hour in a methanol/ion-exchange aqueous solution (volume ratio of 80/20) of sodium hydroxide with a pH of 13 at 25° C. to the hydrophobicity [M value (M_{X})] of 0.8 to 1.0; and

at least one kind of liquid selected from the group consisting of a hydrocarbon oil (B), a non-reactive silicone oil (C) and a polyoxyalkylene compound (D).

<Measurement Method of Hydrophobicity [M values (M_{X}), (M_{Y})]>

Water/methanol mixed solutions in which methanol concentrations are changed at an interval of 2.5% by volume are prepared, and 5 ml of respective mixed solutions are put into separate 10-ml test tubes, then 0.2 g of measurement samples are put into each test tube, and the test tubes are covered, turned upside down twenty times and allowed to stand still. Thereafter, the test tubes are observed, and among mixed solutions in which aggregates are not generated and the measurement samples are all wet and uniformly mixed, a methanol concentration (% by volume) of a mixed solution with a lowest methanol concentration is defined as a hydrophobicity [M value].

A gist of a feature of a method for producing latex according to the present invention lies in that the method comprises a monomer removal step of distilling off an unreacted monomer from a latex polymerization dispersion liquid under reduced pressure, in the presence of the defoaming agent described above.

A gist of a feature of a method for producing a kraft pulp according to the present invention lies in that the method comprises adding the defoaming agent described above to a pulp slurry or a treatment liquid to produce a kraft pulp, in a digestion step, a washing step, a bleaching step, a black liquid concentrated soda recovery step and/or a waste water treatment step.

### Advantageous Effects of Invention

The defoaming agent of the present invention exhibits excellent defoaming persistence. Therefore, by using the defoaming agent of the present invention, defoaming properties persist for a long period.

According to the method for producing latex of the present invention, the monomer removal step is performed in the presence of the defoaming agent, thus an unreacted monomer can be efficiently distilled off from a latex polymerization dispersion liquid under reduced pressure.

According to the method for producing a kraft pulp of the present invention, the defoaming agent is added to a pulp slurry or a treatment liquid to produce a kraft pulp, and a digestion step, a washing step, a bleaching step, a black liquid concentrated soda recovery step and/or a waste water treatment step are performed, thus a kraft pulp can be efficiently produced.

### BRIEF DESCRIPTION OF THE DRAWING

FIG. 1 is a perspective view schematically showing a defoaming property testing device for evaluating a defoaming property in Examples.

### MODE FOR CARRYING OUT THE INVENTION

The hydrophobic silica (A) includes hydrophobic silica obtained by subjecting hydrophilic silica to hydrophobic treatment with a hydrophobizing agent.

The hydrophilic silica includes wet process (precipitated, gel-processed) silica and vapor phase process (pyrogenic, fused) silica. The hydrophilic silica has a silanol group or the like on the silica surface, and thus exhibits hydrophilicity.

The hydrophilic silica is readily commercially available, and examples thereof include the following products and the like.

### <Precipitated Silica>

Nipsil series {Tosoh Silica Corporation; “Nipsil” is a registered trademark of Tosoh Silica Corporation}, Sipernat series {Evonik Degussa Japan Co., Ltd.; “Sipernat” is a registered trademark of Evonik Degussa GMBH.}, Carplex series {DSL. Japan Co., Ltd.; “Carplex” is a registered trademark of DSL. Japan Co., Ltd.}, FINESIL series {Tokuyama Corporation; “FINESIL” is a registered trademark of Oriental Silicas Corporation}, TOKUSIL {Tokuyama Corporation, “TOKUSIL” is a registered trademark of Oriental Silicas Corporation}, Zeosil series {Rhodia; “Zeosil” is a registered trademark of Rhodia Chimie}, MIZUKASIL series {Mizusawa Industrial Chemicals, Ltd.; “MIZUKASIL” is a registered trademark of Mizusawa Industrial Chemicals, Ltd.}, and the like.

### <Gel-Processed Silica>

Carplex series {DSL. Japan Co., Ltd.}, SYLYSIA series {Fuji Silysia Chemical Ltd.; “SYLYSIA” is a registered trademark of YUGENKAISHA Y.K.F.}, Nipgel series {Tosoh Silica Corporation; “Nipgel” is a registered trademark of Tosoh Silica Corporation}, MIZUKASIL series {Mizusawa Industrial Chemicals, Ltd.; “MIZUKASIL” is a registered trademark of Mizusawa Industrial Chemicals, Ltd.}, and the like.

### <Fused Silica>

Admafine series {Admatechs Co., Ltd.; “Admafine” is a registered trademark of Admatechs Company Limited.}, Fuselex series {Tatsumori Ltd.}, DENKA fused silica series {Denki Kagaku Kogyo Kabushiki Kaisha}, and the like.

### <Pyrogenic Silica>

Aerosil series {Nippon Aerosil Co., Ltd. and Evonik Degussa GMBH.; “Aerosil” is a registered trademark of Evonik Degussa GMBH.}, Reolosil series {Tokuyama Corporation; “Reorosil” is a registered trademark of Tokuyama Corporation}, Cab-O-Sil series {Cabot Corporation; “Cab-O-Sil” is a registered trademark of Cabot Corporation}, and the like.

Examples of the hydrophobizing agent include halosilanes, alkoxysilanes, hydrosilanes, disilazanes, fatty acids having 4 to 28 carbon atoms, aliphatic alcohols having 4 to 86 carbon atoms, aliphatic amines having 12 to 22 carbon atoms, and silicone compounds.

Examples of the halosilanes include alkylhalosilanes and arylhalosilanes of which the alkyl groups or aryl groups have 1 to 12 carbon atoms, and examples thereof include methyltrichlorosilane, dimethyldichlorosilane, trimethylchlorosilane, trimethylbromosilane, ethyltrichlorosilane, dodecyltrichlorosilane, phenyltrichlorosilane, diphenyldichlorosilane, t-butyldimethylchlorosilane, and the like.

Examples of the alkoxysilanes include alkoxysilanes of which the alkyl groups or aryl groups have 1 to 12 carbon atoms and of which the alkoxy groups have 1 to 2 carbon atoms, and examples thereof include methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, and the like.

Examples of the hydrosilanes include alkylhydrosilanes and arylhydrosilanes of which the alkyl groups or aryl groups have 1 to 18 carbon atoms, and examples thereof include dimethylethylsilane, diethylmethylsilane, tert-butyldimethylsilane, dimethyloctadecylsilane, cvclohexyldimethylsilane, benzyldimethylsilane, diisopropyloctylsilane, triisopropylsilane, tripropylsilane, trihexylsilane, trioctylsilane, trisdecylsilane, pentamethyldisiloxane, tetramethyldisilane, tetramethyldisiloxane, heptamethyldisiloxane, and the like.

Examples of the disilazanes include tetramethyldisilazane and the like.

Examples of the fatty acids having 4 to 28 carbon atoms include butanoic acid, hexanoic acid, lauric acid, stearic acid, oleic acid, behenic acid, montanic acid, and the like.

Examples of the aliphatic alcohols having 4 to 36 carbon atoms include n-butyl alcohol, n-amyl alcohol, n-octanol, lauryl alcohol, stearyl alcohol, behenyl alcohol, and the like.

Examples of the aliphatic amines having 12 to 22 carbon atoms include dodecylamine, stearylamine, oleylamine, and the like.

Examples of the silicone compounds include dimethylpolysiloxanes, aryl-modified polysiloxanes (the aryl group having 6 to 10 carbon atoms), alkyl-modified polysiloxanes (the alkyl group having 2 to 6 carbon atoms), amino group-modified polysiloxanes, 3 to 5-mer cyclic silicones, methylhydrogenpolysiloxanes, reaction products of a dimethylpolysiloxane or a 3 to 5-mer cyclic silicone and a methylhydrogenpolysiloxane, silicone resins, and the like.

As the dimethylpolysiloxane, one having a kinematic viscosity (at 25° C.) of 0.65 to 1,000 mm²/s and the like can be used.

As the aryl-modified polysiloxanes and alkyl-modified polysiloxanes, one having a kinematic viscosity (at 25° C.) of 1 to 10,000 mm²/s and the like can be used.

As the amino group-modified polysiloxanes, one having a kinematic viscosity (at 25° C.) of 1 to 10,000 mm²/s and the like can be used.

As the 3 to 5-mer cyclic silicones, hexamethylcyclotrisiloxane, octamethylcyclotetrasiloxane, decamethylcyclopentanesiloxane and the like can be used.

As the methylhydrogenpolysiloxane, one having a kinematic viscosity (at 25° C.) of 1 to 10,000 mm²/s and the like can be used.

As the reaction products of a dimethylpolysiloxane and a methylhydrogenpolysiloxane, one obtained by mixing the dimethylpolysiloxane and the methylhydrogenpolysiloxane at room temperature (about 25° C.) using concentrated sulfuric acid as a catalyst, and having a kinematic viscosity (at 25° C.) of 1 to 10,000 mm²/s and the like can be used.

As the silicone resins, an MQ resin comprising any combination of triorganosiloxy unit (M unit) and siloxy unit (Q unit) and the like can be used. Also, when using a silicone resin as the hydrophobizing agent, it is preferable to use the silicone resin in the form of a solution including the silicone resin dissolved in cyclic silicone, low-viscosity chain-like silicone or the like.

As the hydrophobizing agent to be used for hydrophobic treatment, publicly known coupling agents (silane coupling agents other than those mentioned above, titanate coupling agents, zircoaluminate coupling agents, and the like) and the like can be also used, in addition to those mentioned above.

Of these hydrophobizing agents, halosilanes, alkoxysilanes, hydrosilanes, disilazanes and silicone compounds are preferred, hydrosilanes, disilazanes and silicone compounds are further preferred, and hydrosilanes, disilazanes, dimethylpolysiloxanes, methylhydrogenpolysiloxanes, the reaction products of a dimethylpolysiloxane and a methylhydrogenpolysiloxane and silicone resins are particularly preferred.

In the hydrophobic treatment, publicly known methods can be applied. For example, a method of adsorbing or reacting the hydrophobizing agent on/with the surface of hydrophilic silica (wet hydrophobic treatment) while stirring a hydrophobic treatment solvent {at least one kind of liquid selected from the group consisting of a hydrocarbon oil (B), a non-reactive silicone oil (C) and a polyoxyalkylene compound (D), and/or a hydrophobic organic solvent}, the hydrophilic silica, and the hydrophobizing agent, can be applied. In this case, when at least one kind of liquid selected from the group consisting of a hydrocarbon oil (B), a non-reactive silicone oil (C) and a polyoxyalkylene compound (D) is used as the hydrophobic treatment solvent, it may be removed (distilled, filtered, washed, etc.) or may be left as it is, as necessary. On the other hand, when a hydrophobic organic solvent is used as the hydrophobic treatment solvent, the hydrophobic organic solvent is preferably removed (distilled, filtered, washed, etc.). Also, in addition to the wet hydrophobic treatment, a method of adsorbing or reacting the hydrophobizing agent on/with the surface of hydrophilic silica (dry hydrophobic treatment) while stirring the hydrophilic silica and the hydrophobizing agent can be also applied.

As the hydrocarbon oil (B), mineral oils, animal and vegetable oils, synthetic lubricating oils and the like can be used.

Examples of the mineral oils include spindle oils, machine oils, refrigerant oils, and the like. Examples of the animal and vegetable oils include fish oils, rapeseed oils, soybean oils, sunflower seed oils, cotton seed oils, peanut oils, rice bran oils, corn oils, safflower oils, olive oils, sesame oils, evening primrose oils, palm oils, shea fats, sal fats, cacao butters, coconut oils, palm kernel oils, and the like. Examples of the synthetic lubricating oils include polyolefin oils (a-olefin oils), polyglycol oils, polybutene oils, alkylbenzene oils (alkylate oils), isoparaffin oils, and the like.

Examples of the hydrocarbon oil (B) preferably include mineral oils and/or synthetic lubricating oils, and further preferably include mineral oils and/or synthetic lubricating oils having a kinematic viscosity (mm²is, at 40° C.) of 0.5 to 30 (preferably 0.8 to 27, further preferably 1 to 25).

The mineral oils, animal and vegetable oils and synthetic lubricating oils are readily commercially available, and examples of the mineral oils and synthetic lubricating oils include COSMO SC22 (21 mm²/s), COSMO SP10 (10 mm²/s), COSMO RC spindle oil (10 mm²/s), COSMO RB spindle oil (15 mm²/s), COSMO NEUTRAL 150 (32 mm²/s), COSMO PURESPIN G (21 mm²/s), and COSMO PURESPIN E (5 mm²/s) (COSMO OIL LUBRICANTS Co., Ltd.; “COSMO” is a registered trademark of COSMO OIL Co., Ltd.); NISSEKI SUPER OIL C (93 mm²/s), NISSEKI SUPER OIL D (141 mm²/s), and NISSEKI SUPER OIL B (54 mm²/s) (Shin Nippon Oil Corporation); STANOL 43N (27 mm/s), STANOL 52 (56 mm²/s), STANOL 69 (145 mm/s), STANOL 35 (9 mm/s), and STANOL LP35 (11 mm²/s) (Esso Sekiyu K. K.); and FUKKOL SH SPIN (9 mm²/s), FUKKOL NT100 (21 mm²/s), FUKKOL NT150 (28 mm²/s), FUKKOL NT200 (39 mm²/s), FUKKOL NT60 (10 mm²/s), and FUKKOL ST MACHINE (9 mm²/s) (FUJI KOSAN, Co., LTD.; “FUKKOL” is a registered trademark of Shin Nippon Oil Corporation); EXXOL D80 (1.7 mm²/s) and EXXOL DUO (2.5 mm²/s) (TonenGeneral Sekiyu K.K.; “EXXOL” is a registered trademark of Exxon Mobil Corporation) (numbers in parentheses represent “kinematic viscosity (at 40° C.)”.), and the like. Examples of the animal and vegetable oils include FINE OIL N, FINE OIL LR-1, FINE OIL ISB-12 (Miyoshi Oil & Fat Co., Ltd.), and the like.

Examples of the non-reactive silicone oil (C) include dimethylpolysiloxanes, polyether-modified polysiloxanes, and the like.

Dimethylpolysiloxanes (among dimethylpolysiloxanes usable as a hydrophobizing agent (a kinematic viscosity of 0.65 to 1000 mm²/s), dimethylpolysiloxanes having a kinematic viscosity of 500 to 1000 mm²/s are also included) have a kinematic viscosity (at 25° C.; mm²/s) of preferably 500 to 500,000, and further preferably 1000 to 50,000.

As the polyether-modified polysiloxanes, one having a kinematic viscosity (at 25° C.) of 1 to 10000 mm²/s and an HLB of 2 to 5 and the like can be used.

The HLB is a concept that indicates the balance between hydrophilic groups and hydrophobic groups in a molecule, and the HLB value of polyether-modified polysiloxane can be calculated as follows by the “Method for Measuring HLB by Emulsification Test” disclosed in “Properties and Applications of Surfactants”, pp. 89-90, (authored by Kariyone Takao, publisher: Saiwai Shobo, published Sep. 1, 1980).

### <Method for Measuring HLB of Polyether-Modified Polysiloxane by Emulsification Test>

A polyether-modified polysiloxane (γ) whose HLB is unknown and an emulsifier (α) whose HLB is known are mixed in different ratios, and oils (β) with known HLB are emulsified. The HLB of the poly ether-modified polysiloxane (γ) is calculated from the mixing ratio achieved when the thickness of the emulsified layer is the maximum by using the following equation.

HLB_{Γ}={(HLB_{β})×(W_{α}+W_{γ})−(W_{α}×HLB_{α})}/W_{γ}

W_{α} is the weight fraction of the emulsifier (α) based on the total weight of the polyether-modified polysiloxane (γ) and the emulsifier (α), W_{γ} is the weight fraction of the polyether-modified polysiloxane (γ) based on the total weight of the polyether-modified polysiloxane (γ) and the emulsifier (α), HLB_{α} is the HLB of the emulsifier (α), HLB_{β} is the HLB of the oil (β), and HLB_{γ} is the HLB of the polyether-modified polysiloxane (γ).

Among the non-reactive silicone oils (C), dimethylpolysiloxanes and polyether-modified polysiloxanes are preferable, and dimethylpolysiloxanes are further preferable.

Examples of the polyoxyalkylene compound (D) include organic compounds having a polyoxyalkylene group (the number of carbon atoms of the oxyalkylene group is 2 to 4) (but do not include polyether-modified polysiloxane), and examples thereof include polyoxyethylene (mono/di)alkyl ether, polyoxyethylene polyoxypropylene (mono/di)alkyl ether, polyoxyethylene alkyl aryl ether, polyoxypropylene glycol, polyoxypropylene (mono/di)alkyl ether, fatty acid esters of polyoxyalkylene alkyl ether, fatty acid (mono/di)esters of polyoxyethylene glycol, polyoxyethylene polyoxypropylene block polymer, fatty acid (mono/di)esters of polyoxyethylene polyoxypropylene block polymer, ethylene oxide adducts of vegetable oils, alkylene oxide adducts of glycerol, fatty acid (mono/di/tri)esters of alkylene oxide adducts of glycerol, alkylene oxide adducts of polyglycerol, fatty acid esters of alkylene oxide adducts of polyglycerol, alkylene oxide adducts of sorbitan fatty acid esters, and the like (the number of carbon atoms of the alkyl group is 1 to 20, the number of carbon atoms of the fatty acid is 8 to 20).

Among these, polyoxyethylene (mono/di)alkyl ether, polyoxyethylene polyoxypropylene (mono/di)alkyl ether, polyoxypropylene glycol, polyoxypropylene (mono/di)alkyl ether, fatty acid esters of polyoxyalkylene alkyl ether, fatty acid (mono/di)esters of polyoxyethylene glycol, alkylene oxide adducts of sorbitan fatty-acid esters, polyoxyethylene polyoxypropylene block polymer, fatty acid (mono/di)esters of polyoxyethylene polyoxypropylene block polymer, ethylene oxide adducts of vegetable oils, alkylene oxide adducts of glycerol and fatty acid (mono/di/tri)esters of alkylene oxide adducts of glycerol are preferable.

As the hydrophobic organic solvent, hydrocarbon solvents (toluene, hexane, xylene, etc.), halogenated hydrocarbons (dichloromethane, trichloromethane, 1,2-dichloroethane, chlorobenzene, etc.) and the like can be used.

In the hydrophobic treatment, at least one kind of liquid selected from the group consisting of the hydrocarbon oil (B), the non-reactive silicone oil (C) and the polyoxyalkylene compound (D), and the hydrophobic organic solvent may be used alone, or two or more kinds thereof may be mixed and used.

In the chemical reaction between the hydrophilic silica and the hydrophobizing agent, a reaction catalyst may be used.

Examples of the reaction catalyst include hydroxides of an alkali metal or an alkaline earth metal (potassium hydroxide, sodium hydroxide, etc.), alcoholates of an alkali metal (potassium methylate, sodium ethylate, etc.), amines (lauryl amine, myristyl amine, palmityl amine, stearyl amine, monoethanol amine, diethanol amine, triethanol amine, diethanol amine, etc.), inorganic acids (sulfuric acid, nitric acid, hydrochloric acid, phosphoric acid, etc.), carboxylic acids (hydroxyacetic acid, trifluoroacetic acid, p-nitrobenzoic acid, etc.), Lewis acids represented by the general formula (1), and the like.

X (-R)₃ (1)

X represents a boron atom or an aluminum atom, and R represents an aryl group having 8 to 12 carbon atoms in which a part or all of hydrogen atoms may be optionally substituted with an alkyl group having 1 to 4 carbon atoms, a halogen atom, a nitro group or a cyano group, and a tertiary alkyl group having 4 to 15 carbon atoms in which a part or all of hydrogen atoms may be optionally substituted with a halogen atom, a nitro group or a cyano group.

Examples of the aryl group having 6 to 12 carbon atoms in which a part or all of hydrogen atoms may be optionally substituted with an alkyl group having 1 to 4 carbon atoms, a halogen atom, a nitro group or a cyano group include phenyl, pentafluorophenyl, p-methylphenyl, p-cyanophenyl, p-nitrophenyl, benzyl, pentafluorobenzyl, naphthyl, heptafluoronaphthyl, hexafluorodiphenyl, and the like.

Examples of the tertiary alkyl group having 4 to 15 carbon atoms in which a part or all of hydrogen atoms may be optionally substituted with a halogen atom, a nitro group or a cyano group include t-butyl, t-pentyl, nonafluoro t-butyl, and the like.

As the Lewis acids represented by the general formula (1), Lewis acids having a bulky substituent are preferable, and examples thereof include triphenylborane, diphenyl-t-butylborane, tri(t-butyl)borane, triphenylaluminum, diphenyl-t-butylaluminum, tri(t-butyl)aluminum, tris(pentafluorophenyl)borane, bis(pentafluorophenyl)-t-butylborane, tris(pentafluorophenyl)aluminum, bis(pentafluorophenyl)-t-butylaluminum, bis(pentafluorophenyl)fluoroborane, bis(pentafluorophenyl)hexafluorodiphenylfluoroborane; di(t-butyl)fluoroborane, (pentafluorophenyl)difluoroborane, (t-butyl)difluoroborane, bis(pentafluorophenyl)fluoroaluminum, di(t-butyl)fluoroaluminum, (pentafluorophenyl)difluoroaluminum, (t-butyl)difluoroaluminum, and the like.

Among these reaction catalysts, hydroxides of an alkali metal, alcoholates of an alkali metal, amines and Lewis acids represented by the general formula (1) are preferable.

When the reaction catalyst is used, the use amount (% by weight) thereof is preferably 0.01 to 100, further preferably 0.05 to 75, and particularly preferably 0.1 to 50, based on the weight of the hydrophobizing agent.

The hydrophilic silica or hydrophobic silica may be pulverized before or after the hydrophobic treatment. When performing pulverization treatment, one treatment of the hydrophobic treatment and the pulverization treatment may be previously performed, and the other treatment may be performed thereafter, or the hydrophobic treatment and the pulverization treatment may be performed in parallel, and the order of the hydrophobic treatment and the pulverization treatment is not limited. The pulverization treatment is preferably wet-pulverization treatment. Also, the hydrophobic treatment is preferably wet hydrophobic treatment.

The use amount (% by weight) of the hydrophobizing agent is preferably 1 to 50, further preferably 3 to 40, and particularly preferably 5 to 30, based on the weight of the hydrophilic silica. When the use amount is within this range, defoaming persistence becomes better.

The hydrophobicity [M value (M_{X})] of the hydrophobic silica (A) is preferably 50 to 85, further preferably 55 to 80, and particularly preferably 60 to 75. When the hydrophobicity is within this range, defoaming persistence becomes better.

The rate of change (M_{Y}/M_{X}) of a hydrophobicity [M value (M_{Y})] after immersion for 1 hour in a methanol/ion-exchange aqueous solution (volume ratio of 80/20) of sodium hydroxide with a pH of 13 at 25° C. to the hydrophobicity [M value (M_{X})] is preferably 0.8 to 1.0, and further preferably 0.9 to 1.0. When the rate of change is within this range, defoaming persistence becomes better. It is considered that the rate of change (M_{Y}/M_{X}) does not exceed 1.0.

The hydrophobicity [M values (M_{X}), (M_{Y})] is a characteristic value that represents a degree of hydrophobic treatment on a powder surface, and indicates that the higher the hydrophobicity [M value], the lower the hydrophilicity, and the ratio of hydrophobic treatment is high (hydrophobicity is high). The hydrophobicity is represented by the volume ratio of methanol in a minimum amount required for uniformly dispersing a powder (particles to be measured) in a water/methanol mixed solution and can be determined by the following method.

<Measurement Method of Hydrophobicity [M values (M_{X}), (M_{Y})]>

### (1) Pretreatment

When a sample contains a hydrocarbon oil (B) and/or a non-reactive silicone oil (C), 10 g of the sample and 40 g of hexane are mixed, and then separated into a solid {containing hydrophobic silica (A)} and a liquid {containing hexane, the hydrocarbon oil (B) and/or the non-reactive silicone oil (G)} by centrifugation (2880 G, 10 minutes). Subsequently, the solid {containing the hydrophobic silica (A)} and 40 g of hexane are mixed, and separated into a solid and a liquid by centrifugation. Furthermore the similar operations of mixing and centrifugation are repeated three times, and then the hexane remained in the solid is dried by heating at 120° C. for 2 hours to obtain a measurement sample.

On the other hand, when a sample contains a hydrophobic organic solvent, the sample is dried by heating (120° C., 2 hours) to remove the hydrophobic organic solvent, so that a measurement sample is obtained.

### (2) Measurement of Hydrophobicity

Water/methanol mixed solutions in which methanol concentrations are changed at an interval of 2.5% by volume are prepared, and 5 ml of respective mixed solutions are put into separate 10-ml test tubes, then 0.2 g of measurement samples are put into each test tube, and the test tubes are covered, turned upside down twenty times and allowed to stand still. Thereafter, the test tubes are observed, and among mixed solutions in which aggregates are not generated and the measurement samples are all wet and uniformly mixed, a methanol concentration (% by volume) of a mixed solution with a lowest methanol concentration is defined as a hydrophobicity [M value].

(3) Measurement of Hydrophobicity [M value (M_{Y})]

A methanol/ion-exchange aqueous solution (volume ratio of 80/20) in which sodium hydroxide is dissolved at a saturated concentration is added to a methanol/ion-exchange aqueous solution with a volume ratio of 80/20, and the mixed solution is adjusted to a pH of 13, then 0.5 g of a measurement sample {the pretreated sample described above in the case of containing the hydrocarbon oil (B) and/or the non-reactive silicone oil (C)} is mixed with 50 ml of this solution. The mixture is allowed to stand still at 25° C. for 1 hour, the solid was centrifuged (2880 G, 10 minutes), and washing operations including mixing the solid and 40 g of methanol and centrifuging the mixture are performed three times. The solid is dried by heating at 120° C. for 2 hours, and then hydrophobicity is measured in the same manner as in the measurement of the hydrophobicity described above.

The rate of change (M_{Y}/M_{X}) is calculated by dividing the hydrophobicity [M value (M_{Y})] by the hydrophobicity [M value (M_{X})].

The hydrophobicity [M value (M_{X})] can be adjusted by the kind and use amount of the hydrophobizing agent, and the like.

The lower the degree of hydrophobicity of the hydrophobizing agent, the smaller the hydrophobicity [M value (M_{X})] tends to be, and the higher the degree of hydrophobicity of the hydrophobizing agent, the larger the hydrophobicity [M value (M_{X})] tends to be. Moreover, the above hydrophobicity [M value (M_{X})] can be achieved by using the above hydrophobizing agent.

The smaller the use amount of the hydrophobizing agent, the smaller the hydrophobicity [M value (M_{X})] tends to be, and the larger the use amount of the hydrophobizing agent, the larger the hydrophobicity [M value (M_{X})] tends to be. Moreover, when the use amount of the hydrophobizing agent is as described above, the hydrophobicity [M value (M_{X})] tends to be within the above range of the hydrophobicity [M value (M_{X})]. Even if the use amount of the hydrophobizing agent is increased exceeding the above range, the hydrophobicity [M value (M_{X})] would not be large as exceeding the above range.

The rate of change (M_{Y}/M_{X}) can be adjusted by the kind and use amount of the hydrophobizing agent, the kind and use amount of the reaction catalyst, and the time and temperature of the hydrophobic treatment, and the like.

When the hydrophobizing agent is a hydrosilane, a disilazane, a methylhydrogenpolysiloxane, or a reaction product of a dimethylpolysiloxane and a methylhydrogenpolysiloxane, and the reaction catalyst is a hydroxide of an alkali metal, an alcoholate of an alkali metal or an amine, the larger the use amount of the hydrophobizing agent, or the larger the use amount of the reaction catalyst, or the higher the temperature of the hydrophobic treatment, or the longer the time of the hydrophobic treatment, the higher the rate of change (M_{Y}/M_{X}) tends to be. On the other hand, the smaller the use amounts thereof, or the lower the temperature of the hydrophobic treatment, or the shorter the time of the hydrophobic treatment, the smaller the rate of change (M_{Y}/M_{X}) tends to be.

When the hydrophobizing agent is a hydrosilane, a methylhydrogenpolysiloxane, or a reaction product of a dimethylpolysiloxane or a 3 to 5-mer cyclic silicone and a methylhydrogenpolysiloxane, and the reaction catalyst is a Lewis acid represented by the general formula (1), the larger the use amount of the hydrophobizing agent, or the larger the use amount of the reaction catalyst, the higher the rate of change (M_{Y}/M_{X}) tends to be. On the other hand, the smaller the use amounts thereof, the smaller the rate of change (M_{Y}/M_{X}) tends to be. In this case, the temperature of the hydrophobic treatment may be about 5 to 120° C. (preferably 15 to 80° C., and further preferably 20 to 60° C.), and the rate of change (M_{Y}/M_{X}) does not become high even if the temperature is increased exceeding this range. Also, the rate of change (M_{Y}/M_{X}) does not become high even if the time of the hydrophobic treatment is extended due to the reason that the hydrophobic treatment is rapidly completed.

When the hydrophobizing agent is a dimethylpolysiloxane or a silicone resin, and the reaction catalyst is a hydroxide of an alkali metal, an alcoholate of an alkali metal or an amine, the larger the use amount of the hydrophobizing agent, or the larger the use amount of the reaction catalyst, or the higher the temperature of the hydrophobic treatment, or the longer the time of the hydrophobic treatment, the higher the rate of change (M_{Y}/M_{X}) tends to be. On the other hand, the smaller the use amounts thereof, or the lower the temperature of the hydrophobic treatment, or the shorter the time of the hydrophobic treatment, the smaller the rate of change (M_{Y}/M_{X}) tends to be.

The volume-average particle diameter (μm) of the hydrophobic silica (A) is preferably 1 to 20, further preferably 1.5 to 15, and particularly preferably 2 to 11. When the volume-average particle diameter is within this range, defoaming persistence becomes better.

The volume-average particle diameter is determined as a 50% cumulative volume-average particle diameter using 1.3749 as the refractive index of 2-propanol and the literature values (“A GUIDE FOR ENTERING MICROTRAC “RUN INFORMATION” (F3) DATA”, produced by Leeds & Northrup) as the refractive index of a measurement sample, by adding 1 part by weight of a measurement sample to 1000 parts by weight of 2-propanol {purity of 99% by weight or more} to prepare a measurement dispersion liquid, and performing the measurement at a measuring temperature of 25±5° C. by use of a laser diffraction particle size analyzer {e.g., Microtrac series manufactured by Leeds & Northrup and Partica LA series manufactured by HORIBA, Ltd.} in accordance with JIS Z8825: 2013 (corresponding international standard: ISO 13320).

When the sample contains at least one kind of liquid selected from the group consisting of the hydrocarbon oil (B), the non-reactive silicone oil (C) and the polyoxyalkylene compound (D), and the hydrophobic organic solvent, the measurement sample is pretreated in the same manner as in (1) Pretreatment of

<Measurement Method of Hydrophobicity [M values (M_{X}), (M_{Y})]>.

The content (% by weight) of at least one kind of liquid selected from the group consisting of the hydrocarbon oil (B), the non-reactive silicone oil (C) and the polyoxyalkylene compound (D) is preferably 400 to 9900, and further preferably 700 to 1800, based on the weight of the hydrophobic silica (A). When the content is within this range, defoaming persistence becomes better.

The defoaming agent of the present invention can further contain a surfactant (E).

Examples of the surfactant (E) include an anionic surfactant, a nonionic surfactant {the polyoxyalkylene compound (D) is not included}, and a mixture thereof.

The defoaming agent of the present invention may further contain a hydrophobic compound (F) selected from an amide, a wax and a metallic soap.

Examples of the amide include a reaction product (fatty acid diamide) of an alkylenediamine or alkenylenediamine having 1 to 6 carbon atoms with a fatty acid having 10 to 22 carbon atoms and/or a reaction product (fatty acid monoamide) of an alkylamine or alkenylamine having 1 to 22 carbon atoms or ammonia with a fatty acid having 10 to 22 carbon atoms.

Examples of the fatty acid diamide include ethylene bisstearylamide, ethylene bispalmitylamide, ethylene bismyristylamide, ethylene bislaurylamide, ethylene bisoleylamide, propylene bisstearylamide, propylene bispalmitylamide, propylene bismyristylamide, propylene bislaurylamide, propylene bisoleylamide, butylene bisstearylamide, butylene bispalmitylamide, butylene bismyristylamide, butylene bislaurylamide, butylene bisoleylamide, methylene bislaurylamide, methylene bisstearylamide, hexamethylene bisstearylamide, and the like.

Examples of the fatty acid monoamide include N-stearylstearylamide, oleic acid amide, erucic acid amide, stearylamide, and the like.

Among these, the fatty acid diamide is preferred, and further, ethylene bisstearylamide, ethylene bispalmitylamide, ethylene bislaurylamide, methylene bisstearylamide and hexamethylene bisstearylamide are preferred, and particularly, ethylene bisstearylamide, ethylene bispalmitylamide, and ethylene bismyristylamide are preferred, from the viewpoint of defoaming persistence and the like. These amides may be a mixture of two or more thereof, and in the case of a mixture, it is preferred that any of the aforementioned preferable fatty acid diamides be contained as a main component.

The main component means a component that is contained in an amount of at least 40% by weight, based on the weight of the fatty acid amide, and the component is contained preferably in an amount of 50% by weight or more, further preferably in an amount of 60% by weight or more, particularly preferably in an amount of 70% by weight or more, and most preferably in an amount of 80% by weight or more.

Examples of sub-components (components contained other than the main component) in the fatty acid amide include an unreacted amine, an unreacted carboxylic acid and the like, in addition to amides other than the amides within the aforementioned preferable range. The content (% by weight) of the sub-components is preferably less than 60, further preferably less than 50, particularly preferably less than 40, even more preferably less than 30, and most preferably less than 20, based on the weight of the fatty acid amide.

The wax preferably includes at least one kind selected from the group consisting of oxidized polyethylene wax, microcrystalline wax, hydroxide group-containing wax, paraffin wax and natural wax, and examples thereof include oxidized polyethylene wax, microcrystalline wax, paraffin wax, alcohol-modified wax, maleic acid-modified wax, ethylene-vinyl acetate copolymer wax, ethylene-acrylic acid copolymer wax, Fischer-Tropsch wax, Japan wax, beeswax, palm wax, carnauba wax, montan wax, and the like.

Examples of the metallic soap include salts of a fatty acid having 12 to 22 carbon atoms with a metal (alkaline earth metal, aluminum, manganese, cobalt, copper, iron, zinc, nickel, etc.), and examples thereof include aluminum stearate, manganese stearate, cobalt stearate, copper stearate, iron stearate, nickel stearate, calcium stearate, zinc laurate, magnesium behenate, and the like.

In the metallic soap, the relation of the amounts between the metal and the fatty acid may be any of 1 to 8 moles of the fatty acid based on 1 mol of the metal (mono-material, di-material, tri-material), and a mixture of mono-material, di-material and tri-material may be used. From the viewpoint of defoaming persistence, when the metal is aluminum and iron, di-material and tri-material are preferred, and when the metal is an alkaline earth metal (calcium, etc.), zinc, cobalt, manganese, nickel and copper, di-material is preferred.

As the hydrophobic compound (F), only one kind thereof may be used, or two or more kinds thereof may be mixed.

As long as the defoaming agent of the present invention is produced by uniformly mixing the hydrophobic silica (A), at least one kind of liquid selected from the group consisting of the hydrocarbon oil (B), the non-reactive silicone oil (C) and the polyoxyalkylene compound (D), and the surfactant (E) and/or the hydrophobic compound (F) as necessary, the production method thereof is not limited. In the hydrophobic treatment for preparing the hydrophobic silica (A), when at least one kind of liquid selected from the group consisting of the hydrocarbon oil (B), the non-reactive silicone oil (C) and the polyoxyalkylene compound (D) is used, the resulting mixture may be used as the defoaming agent of the present invention as it is without removing this liquid, or this liquid may be additionally mixed.

For uniform mixing, a publicly known mixer can be used, and for example, an emulsifying disperser (bead mill, sand mill, disper mill, homogenizer, or Gaulin homogenizer, etc.) may be used.

When the defoaming agent of the present invention contains the hydrophobic compound (F), the defoaming agent of the present invention is preferably produced by a method including a step (1) of obtaining a solution by dissolving the hydrophobic compound (F) while heating and stirring the hydrophobic compound (F) with a part of at least one kind of liquid selected from the group consisting of the hydrocarbon oil (B), the non-reactive silicone oil (C) and the polyoxyalkylene compound (DK and a step (2) of obtaining a mixture by charging the solution into a residue of this solution while stirring the residue. Furthermore, the production method may include a step (3) of obtaining a mixture by uniformly mixing the mixture.

In this case, the heating and stirring temperature (° C.), which is not limited as long as the hydrophobic compound (F) can be dissolved, is preferably 100 to 180. Also, the heating and stirring time, which is not limited as long as the hydrophobic compound (F) can be dissolved, is preferably set to be as short as possible, in order to prevent oxidation and evaporation of the liquid and the like. Moreover, the heating and stirring may be carried out under sealing (and optionally under pressure) or may be carried out under opening.

In the step (2), it is preferred to heat and stir the solution even while charging the solution and to maintain the state that the hydrophobic compound (F) is dissolved in the solution. Also, in the step (2), the temperature of the residue of the liquid is maintained at preferably 0 to 70° C., further preferably 0 to 50° C., and particularly preferably 0 to 40° C., from the viewpoint of defoaming persistence, production cost and the like. More specifically, in the step (2), it is preferred to obtain a mixture by charging the solution little by little into the residue of the liquid being maintained at 0 to 70° C. (preferably in the above range), while stirring the residue of the liquid cooled to 0 to 70° C.

In the step (3), the uniform mixing treatment is not limited as long as the mixture can be uniformly mixed, and it is preferred to perform the uniform mixing treatment by using an emulsifying disperser (bead mill, sand mill, disper mill, homogenizer, or Gaulin homogenizer, etc.). The temperature of the mixture in the uniform mixing treatment is maintained at preferably 0 to 70° C., further preferably 0 to 50° C. and particularly preferably 0 to 40° C. More specifically, in the step (3), it is preferred to obtain a defoaming agent by uniformly mixing the mixture while maintaining a temperature of 0 to 70° C. (preferably 0 to 50° C., and further preferably 0 to 40° C.).

When the defoaming agent of the present invention contains the hydrophobic compound (F), the hydrophobic silica (A) and the surfactant (E) contained as necessary may he mixed in any of the above steps, and may be uniformly mixed after the step (3).

The defoaming agent of the present invention may further contain water, a thickener, a dispersing agent, an antiseptic, an antifreezing agent and/or a diluent solvent, and the like (these may be mixed in any timing).

Examples of the thickener include xanthan gum, locust bean gum. guar gum, carrageenan, alginic acid and salts thereof, tragacanth gum, magnesium aluminum silicate, bentonite, synthetic hydrous silicic acid, and synthetic polymer type thickeners containing a carboxyl group (examples of product name include SN-Thickener 636 and SN-Thickener 641; SAN NOPCO Ltd.), and association type thickeners containing a polyoxyethylene chain (examples of trade name include SN-Thickener 625N and SN-Thickener 665T; SAN NOPCO Ltd.), and the like.

Examples of the dispersing agent include polyacrylic acid (salt), partially saponified polyvinyl alcohol, sulfonated polyvinyl alcohol, and the like.

As the antiseptic, a publicly known antiseptic (Dictionary of Antibacterial and Antifungal Agents, 1st Ed., pp. 1-32, published by The Society for Antibacterial and Antifungal Agents, Japan, 1986, etc.) and the like can be used, and examples thereof include formalin, 5-chloro-2-methyl-4-isothiazolin-3-one, and the like.

Examples of the antifreezing agent include ethylene glycol, propylene glycol, glycerol, and the like,

As the diluent solvent, a publicly known diluent solvent (Solvent Handbook, pp. 143-881, published by Kodansha, 1978, etc.) and the like can be used, and examples thereof include butylcellosolve, propylene glycol monopropyl ether, 1-butanol, and the like.

The defoaming agent of the present invention may be used as it is, or may be diluted with a diluent solvent, water, an aqueous solution or the like and used, or may be loaded onto a powder of silica or calcium carbonate or the like and used.

The defoaming agent of the present invention is effective to an aqueous foamable liquid, and for example, is applicable to air bubbles that generate during various processes such as synthetic rubber manufacturing process (particularly, monomer removal step of distilling off an unreacted monomer from a latex polymerization dispersion liquid under reduced pressure); paper pulp manufacturing process (particularly, process for manufacturing a kraft pulp including adding the deforming agent to a pulp slurry or a treatment liquid to produce a kraft pulp, in a digestion step, a washing step, a bleaching step, a black liquid concentrated soda recovery step and/or a waste water treatment step); construction industry or its sheet making step; dyestuff industry; dyeing industry; fermentation industry; synthetic resin manufacturing industry; ink and paint-industry; fiber processing industry; and the like. Among them, the defoaming agent of the present invention is suitable as a defoaming agent for synthetic rubber manufacturing process and paper pulp manufacturing process, and is further suitable as a defoaming agent for a monomer removal step of distilling off an unreacted monomer from a latex polymerization dispersion liquid under reduced pressure and for a digestion step, a washing step, a bleaching step, a black liquid concentrated soda recovery step and/or a waste water treatment step.

The defoaming agent of the present invention can be added to a liquid to be added by a batch addition method, a continuous addition method, an intermittent method, or a method of interlocking a foam measuring device and a defoaming agent adding device, or the like. Also, either one point addition or multipoint addition may be used.

The defoaming agent of the present invention may be used together with a publicly known defoaming agent {for example, polyether defoaming agents, silicone defoaming agents (JP-B-51-35556, JP-A-52-2887, JP-B-52-19836, JP-B-55-23084, JP-A-06-142410 and JP-A-06-142411, etc.), mineral oil defoaming agents (JP-B-49-109276, JP-A-52-22356, JP-A-54-32187, JP-A-55-70308 and JP-A-56-136610, etc.), and wax emulsion defoaming agents (JP-A-47-114336, JP-A-60-156516, JP-A-62-171715, JP-A-64-68595, JP-A-01-210005 and JP-A-04-349904, etc.)} or the like.

The addition amount (% by weight) of the defoaming agent of the present invention may be properly set according to the foaming state, temperature, viscosity and the like of the liquid to be added (namely, foamable liquid), and is preferably 0.001 to 5, further preferably 0.005 to 2, and particularly preferably 0.01 to 1, based on the weight of the liquid to be added. The addition temperature is preferably about 0 to 100° C.

### EXAMPLE

The present invention will be described below in more detail by examples, but the present invention is not limited thereto. Unless otherwise stated, part(s) and % mean part(s) by weight and % by weight, respectively.

### Production Example 1

In a container capable of stirring and cooling, stirring of 873 parts of octamethylcyclotetrasiloxane {KF-994, Shin-Etsu Chemical Co., Ltd.}, 123 parts of methylhydrogenpolysiloxane {KF-99, Shin-Etsu Chemical Co., Ltd.} and 4 parts of sulfuric acid was continued at 25° C. for 3 hours. Then, the resulting mixture was washed with water using a separating funnel, until pH of washing water became 7, and separated to obtain a hydrophobizing agent (S1).

### Production Example 2

In a container capable of stirring and cooling, stirring of 796 parts of dimethylpolysiloxane {KF-96L-0.65cs, Shin-Etsu Chemical Co., Ltd.}, 200 parts of methylhydrogenpolysiloxane {KF-99, Shin-Etsu Chemical Co., Ltd.} and 4 parts of sulfuric acid was continued at 25° C. for 3 hours. Then, the resulting mixture was washed with water using a separating funnel, until pH of washing water became 7, and separated to obtain a hydrophobizing agent (S2).

### Production Example 3

In a container capable of heating, stirring and cooling, 20 parts of a hydrophobic compound (F1) {ALFLOW H-50S, NOF Corporation, ethylene bisstearylamide} and 480 parts of a hydrocarbon oil (B1) {COSMO SC22, COSMO OIL LUBRICANTS Co., Ltd., mineral oil} were heated to 145° C. under heating and stirring, and heating and stirring were further continued at this temperature for additional 15 minutes to obtain a hydrophobic compound solution (BF1).

Subsequently, while 500 parts of the hydrocarbon oil (B1) adjusted to 25° C. was cooled and stirred, the hydrophobic compound solution (BF1) at 145° C. was charged thereto little by little, and the mixture was stirred for 15 minutes to obtain a mixture (BF1). The temperature of the mixture (BF1) during and after charging of the hydrophobic compound solution was 25 to 70° C.

The mixture (BF1) was subjected to homogenizing treatment at 3500 psi (24.1 MPa) by using a Gaulin homogenizer (manufactured by Manton Gaulin MANUFACTURING CO., INC.) to obtain a hydrophobic compound mixture (BF1).

### Example 1

In a container capable of heating, reducing pressure, stirring and cooling, 125 parts of hydrophilic silica {Nipsil G300, Tosoh Silica Corporation}, 22 parts of a hydrophobizing agent (S3) {KF-99, Shin-Etsu Chemical Co., Ltd., methylhydrogenpolysiloxane}, 843 parts of a hydrocarbon oil (B1) {COSMO SC22, COSMO OIL LUBRICANTS Co., Ltd., mineral oil, a kinematic viscosity at 40° C. of 22 mm²/s}, 5 parts of a reaction catalyst (1) {sodium ethoxide} and 5 parts of a reaction catalyst (2) {diethanol amine} were heated to 130° C. under heating and stirring, and heating and stirring were continued at this temperature for 3 hours and further continued under reduced pressure for additional 7 hours to obtain a dispersion liquid (1) containing hydrophobic silica (A1).

The hydrophobic silica (A1) had a volume-average particle diameter of 10.0 μm, a hydrophobicity [M value (M_{X})] of 60, a hydrophobicity [M value (M_{Y})] of 55, and a rate of change (M_{Y}/M_{X}) of 0.92.

Subsequently, in a container capable of heating, stirring and cooling, 700 parts of the dispersion liquid (1), 260 parts of the hydrocarbon oil (B1) {COSMO SC22, COSMO OIL LUBRICANTS Co., Ltd., mineral oil, a kinematic viscosity at 40° C. of 22 mm²/s}, 20 parts of a polyoxyalkylene compound (D1) (IONET DO-600, Sanyo Chemical Industries, Ltd., polyoxyethylene dioleate, “IONET” is a registered trademark) and 20 parts of a polyoxyalkylene compound (D2) {NAROACTY CL-40, Sanyo Chemical Industries, Ltd., polyoxyethylene alkylene ether, “NAROACTY” is a registered trademark} were uniformly mixed to obtain a defoaming agent (1) of the present invention.

### Example 2

A dispersion liquid (2) containing hydrophobic silica (A2) was obtained in the same manner as in Example 1, except for changing the “hydrophobizing agent (S3) {KF-99}” to a “hydrophobizing agent (S1)”.

The hydrophobic silica (A2) had a volume-average particle diameter of 10.0 μm, a hydrophobicity [M value (M_{X})] of 75, a hydrophobicity [M value (M_{Y})] of 70, and a rate of change (M_{Y}/M_{X}) of 0.93.

Subsequently, a defoaming agent (2) of the present invention was obtained in the same manner as in Example 1, except for changing the “dispersion liquid (1) obtained in <Example 1>” to the “dispersion liquid (2) obtained in <Example 2>”.

### Example 3

In a container capable of heating, reducing pressure, stirring and cooling, 125 parts of hydrophilic silica {Nipsil G300, Tosoh Silica Corporation}, 20 parts of a hydrophobizing agent (S2), 17 parts of a hydrophobizing agent (S4) {tetramethyldisilazane, Wako Pure Chemical Industries, Ltd.} and 828 parts of a hydrocarbon oil (B1) {COSMO SC22, COSMO OIL LUBRICANTS Co., Ltd., mineral oil} were heated to 130° C. under heating and stirring, and heating and stirring were continued at this temperature for 3 hours, and 5 parts of a reaction catalyst (1) {sodium ethoxide} and 5 parts of a reaction catalyst (2) {diethanol amine} were further added thereto, then heating and stirring were continued under reduced pressure for 7 hours to obtain a dispersion liquid (3) containing hydrophobic silica (A3).

The hydrophobic silica (A3) had a volume-average particle diameter of 10.0 μm, a hydrophobicity [M value (M_{X})] of 80, a hydrophobicity [M value (M_{Y})] of 75, and a rate of change (M_{Y}/M_{X}) of 0.94.

Subsequently, in a container capable of heating, stirring and cooling, 700 parts of the dispersion liquid (3), 215 parts of the hydrocarbon oil (B1) {COSMO SC22, COSMO OIL LUBRICANTS Co., Ltd., mineral oil, a kinematic viscosity at 40° C. of 22 mm²/s}, 25 parts of a polyoxyalkylene compound (D1) {IONET DO-600, Sanyo Chemical Industries, Ltd. , polyoxyethylene dioleate}, 10 parts of a polyoxyalkylene compound (D2) {NAROACTY CL-40, Sanyo Chemical Industries, Ltd., polyoxyethylene alkylene ether}, 25 parts of a surfactant (E1) {IONET S-80, Sanyo Chemical Industries. Ltd., sorbitan monooleate} and 25 parts of water were uniformly mixed to obtain a defoaming agent (3) of the present invention.

### Example 4

In a container capable of heating, reducing pressure, stirring and cooling, 125 parts of hydrophilic silica {Nipsil N300A, Tosoh Silica Corporation}, 30 parts of a hydrophobizing agent (S1) and 841 parts of a hydrocarbon oil (B1) {COSMO SC22, COSMO OIL LUBRICANTS Co., Ltd., mineral oil} were heated to 130° C. and dehydrated under heating and stirring, and then cooled to 25° C. under cooling and stirring. Subsequently, 1 part of a reaction catalyst (3) {trispentafluorophenyl borane} was added thereto at this temperature, stirring was continued for 1 hour, then 3 parts of a reaction catalyst (1) {sodium ethoxide}was further added thereto, and stirring was continued at 25° C. for 1 hour to obtain a dispersion liquid (4) containing hydrophobic silica (A4).

The hydrophobic silica (A4) had a volume-average particle diameter of 10.0 μm, a hydrophobicity [M value (M_{X})] of 75, a hydrophobicity [M value (M_{Y})] of 72.5, and a rate of change (M_{Y}/M_{X}) of 0.97.

Subsequently, in a container capable of heating, stirring and cooling, 700 parts of the dispersion liquid (4), 255 parts of the hydrocarbon oil (B1) {COSMO SC22, COSMO OIL LUBRICANTS Co., Ltd., mineral oil, a kinematic viscosity at 40° C. of 22 mm²/s}, 30 parts of a polyoxyalkylene compound (D1) {IONET DO-BOO, Sanyo Chemical Industries, Ltd., polyoxyethylene dioleate} and 15 parts of a polyoxyalkylene compound (D2) {NAROACTY CL-40, Sanyo Chemical Industries, Ltd., polyoxyethylene alkylene ether} were uniformly mixed to obtain a defoaming agent (4) of the present invention.

### Example 5

A dispersion liquid (5) containing hydrophobic silica (A5) was obtained in the same manner as in Example 4, except for changing the “30 parts of a hydrophobizing agent (S1)” to “20 parts of a hydrophobizing agent (S2), 10 parts of a hydrophobizing agent (S5) {dimethyloctadecylsilane, Sigma-Aldrich Japan limited liability company}”.

The hydrophobic silica (A5) had a volume-average particle diameter of 10.0 μm, a hydrophobicity [M value (M_{X})] of 72.5, a hydrophobicity [M value (M_{Y})]of 72. 5, and a rate of change (M_{Y}/M_{X}) of 1.00.

Subsequently, in a container capable of heating, stirring and cooling, 700 parts of the dispersion liquid (5), 240 parts of the hydrocarbon oil (B1) {COSMO SC22, COSMO OIL LUBRICANTS Co., Ltd., mineral oil, a kinematic viscosity at 40° C. of 22 mm²/s}, 25 parts of a polyoxyalkylene compound (D1) {IONET DO-600, Sanyo Chemical Industries, Ltd., polyoxyethylene dioleate}, 10 parts of a polyoxyalkylene compound (D2) {NAROACTY CL-40, Sanyo Chemical Industries, Ltd., polyoxyethylenealkylene ether} and 25 parts of a surfactant (E1) {IONET S-80, Sanyo Chemical Industries, Ltd., sorbitan monooleate} were uniformly mixed to obtain a defoaming agent (5) of the present invention.

### Example 8

The dispersion liquid (5) obtained in <Example 5> was stirred at 25 to 40° C. for 1 hour using a sand mill (a desk sand mill manufactured by Kansai Paint Co., Ltd., using 1 mm glass beads), to obtain a dispersion liquid (6) containing hydrophobic silica (A6).

The hydrophobic silica (A6) had a volume-average particle diameter of 2 μm, a hydrophobicity [M value (M_{X})] of 72.5, a hydrophobicity [M value (M_{Y})] of 70, and a rate of change (M_{Y}/M_{X}) of 0.97.

Subsequently, a defoaming agent (6) of the present invention was obtained in the same manner as in Example 5, except for changing the “dispersion liquid (5) obtained in <Example 5>” to the “dispersion liquid (6) obtained in <Example 6>”, and changing the “hydrocarbon oil (B1) {COSMO SC22, COSMO OIL LUBRICANTS Co., Ltd., mineral oil, a kinematic viscosity at 40° C. of 22 mm²/s}” to a “hydrocarbon oil (B2) {COSMO PURESPIN E, COSMO OIL LUBRICANTS Co., Ltd., mineral oil, a kinematic viscosity at 40° C. of 5 mm²/s}”.

### Example 7

In a container capable of heating, reducing pressure, stirring and cooling, 80 parts of hydrophilic silica {Nipsil N300A, Tosoh Silica Corporation}, 13 parts of hydrophobizing agent (S1), 603 parts of a non-reactive silicone oil (C1) {SH200-5000cs, Dow Corning Toray Co., Ltd., dimethylpolysiloxane} and 300 parts of a non-reactive silicone oil (C2) {SH200-50000cs, Dow Corning Toray Co., Ltd., dimethylpolysiloxane} were heated to 130° C. and dehydrated under heating and stirring, and then cooled to 25° C. under cooling and stirring. Subsequently, 1 part of a reaction catalyst (3) {trispentafluorophenyl borane} was added thereto at this temperature, stirring was continued for 1 hour, then 3 parts of a reaction catalyst (1) {sodium ethoxide} was further added thereto, and stirring was continued for 1 hour to obtain a dispersion liquid (7) containing hydrophobic silica (A7).

The hydrophobic silica (A7) had a volume-average particle diameter of 10.0 μm, a hydrophobicity [M value (M_{X})] of 75, a hydrophobicity [M value (M_{Y})] of 72.5, and a rate of change (M_{Y}/M_{X}) of 0.97.

Subsequently, in a container capable of heating, stirring and cooling, 550 parts of the dispersion liquid (7), 360 parts of a hydrocarbon oil (B3) {Exxsol D110, Tonen General Sekiyu K.K., mineral oil, a kinematic viscosity at 40° C. of 2.5 mm²/s}, 20 parts of a non-reactive silicone oil (C3) {SF 8410, Dow Corning Toray Co., Ltd., polyether-modified silicone oil}, 10 parts of a polyoxyalkylene compound (D1) {10NET DO-600, Sanyo Chemical Industries, Ltd., polyoxyethylene dioleate}, 10 parts of a polyoxyalkylene compound (D2) {NAROACTY CL-40, Sanyo Chemical Industries, Ltd., polyoxyethylene alkylene ether}, 25 parts of a surfactant (E1) {IONET S-80, Sanyo Chemical Industries, Ltd., sorbitan monooleate} and 25 parts of water were uniformly mixed to obtain a defoaming agent (7) of the present invention.

### Example 8

In a container capable of heating, reducing pressure, stirring and cooling, 125 parts of hydrophilic silica {Nipsil N300A, Tosoh Silica Corporation} was heated to 130° C. and dehydrated under heating and stirring, then cooled to 25° C. under cooling and stirring. Subsequently, 10 parts of a hydrophobizing agent (S3) {KF-99, Shin-Etsu Chemical Co., Ltd., methylhydrogenpolysiloxane}, 861 parts of an organic solvent {toluene} and 1 part of a reaction catalyst (3) {trispentafluorophenyl borane} was added thereto at 25° C., starring was continued for 1 hour, then 3 parts of a reaction catalyst (1) {sodium ethoxide} was further added thereto, and stirring was continued for 1 hour. Subsequently, the organic solvent was removed from the mixture at 120° C. under reduced pressure to obtain hydrophobic silica (A8).

The hydrophobic silica (A8) had a volume-average particle diameter of 10.0 μm, a hydrophobicity [M value (M_{X})] of 50, a hydrophobicity [M value (M_{Y})] of 45, and a rate of change (M_{Y}/M_{X}) of 0.90.

Subsequently, in a container capable of heating, reducing pressure, stirring and cooling, 135 parts of the resulting hydrophobic silica (A8) and 865 parts of a polyoxyalkylene compound (D3) {NEWPOL PP-4000, Sanyo Chemical Industries, Ltd., polyoxypropylene glycol, “NEWPOL” is a registered trademark} were uniformly mixed to obtain a dispersion liquid (8).

Subsequently, in a container capable of heating, stirring and cooling, 700 parts of the dispersion liquid (8), 55 parts of a hydrocarbon oil (B1) {COSMO SC22, COSMO OIL LUBRICANTS Co., Ltd., mineral oil, a kinematic viscosity at 40° C. of 22 mm³/s}, 20 parts of a polyoxyalkylene compound (D1) {IONET DO-600, Sanyo Chemical Industries, Ltd., polyoxyethylene dioleate}, 10 parts of a polyoxyalkylene compound (D2) {NAROACTY CL-40, Sanyo Chemical Industries, Ltd., polyoxyethylene alkylene ether}, 15 parts of a surfactant (E1) {IONET S-80, Sanyo Chemical Industries, Ltd., sorbitan monooleate} and 200 parts of a hydrophobic compound solution (BF1) obtained in <Production Example 3> were uniformly mixed to obtain a defoaming agent (8) of the present invention.

### Comparative Example 1

In a container capable of heating, reducing pressure, stirring and cooling, 125 parts of hydrophilic silica {Nipsil G300, Tosoh Silica Corporation}, 22 parts of a hydrophobizing agent (5) {KF-96-50cs, Shin-Etsu Chemical Co., Ltd., dimethylpolysiloxane} and 853 parts of a hydrocarbon oil (B1) {COSMO SC22, COSMO OIL LUBRICANTS Co., Ltd., mineral oil, a kinematic viscosity at 40° C. of 22 mm²/s} were heated to 130° C. under heating and stirring, and heating and stirring were continued at this temperature for 3 hours under reduced pressure to obtain a dispersion liquid (H1) containing hydrophobic silica (AH1). The hydrophobic silica (AH1) had a volume-average particle diameter of 10.0 μm, a hydrophobicity [M value (M_{X})] of 65, a hydrophobicity [M value (M_{Y})] of 50, and a rate of change (M_{Y}/M_{X}) of 0.77.

Subsequently, a defoaming agent (H1) for comparison was obtained in the same manner as in Example 1, except for changing the “dispersion liquid (1) obtained in <Example 1>” to the “dispersion liquid (H1)”.

### <Evaluation of Defoaming Persistence (1)>

Using the defoaming agents (1) to (8) and (H1) obtained in Examples 1 to 8and Comparative Example 1, defoaming persistence was evaluated as follows. The evaluation results are shown in Table 1.

SB latex [L-1924, Asahi-Kasei Chemicals Corporation] (83.2 parts), ion exchange water (16.6 parts) and sodium alkylbenzene sulfonate [NEWLEX R, NOF Corporation] (0.2 parts) were uniformly stirred and mixed at 25° C. for 10minutes to prepare a foamable test liquid. Thereafter, a 500-ml glass graduated cylinder (hereinafter, referred to as a foaming tube) was immersed in a water bath adjusted to a temperature of 80° C. up to a scale of 95 ml of the foaming tube in an erected state, and 100 ml of the foamable test liquid adjusted to a temperature of 80° C. was put into this foaming tube. Thereto was added dropwise 40 μL (400 ppm as a concentration based on the foamable test liquid) of the defoaming agent with a micropipette, and the varying total capacity of the foam and the foamable test liquid was read at 1 minute and 10 minutes after the start of the test while the foamable test liquid was bubbled by inserting a diffuser stone into the bottom of the foaming tube and conducting nitrogen bubbling at a rate of 200 ml/minute. When the numerical value is small, it means that the defoaming persistence is higher, and this is preferable.

TABLE 1

Total capacity of foam and
foamable test liquid ml

| | | After 1 minute | After 10 minutes |
|---|---|---|---|
| Examples | 1 | 150 | 180 |
| | 2 | 150 | 170 |
| | 3 | 160 | 190 |
| | 4 | 150 | 160 |
| | 5 | 140 | 150 |
| | 6 | 130 | 150 |
| | 7 | 120 | 130 |
| | 8 | 180 | 220 |
| Comparative | 1 | 170 | — |
| Examples | | | |

In the table, “—” shows that the value exceeded 400 ml that could be measured, and the measurement was stopped.

### <Evaluation of Defoaming Persistence (2)>

Using the defoaming agents (1) to (8) and (H1) obtained in Examples 1 to 8 and Comparative Example 1, defoaming persistence was evaluated as follows. The evaluation results are shown in Table 2.

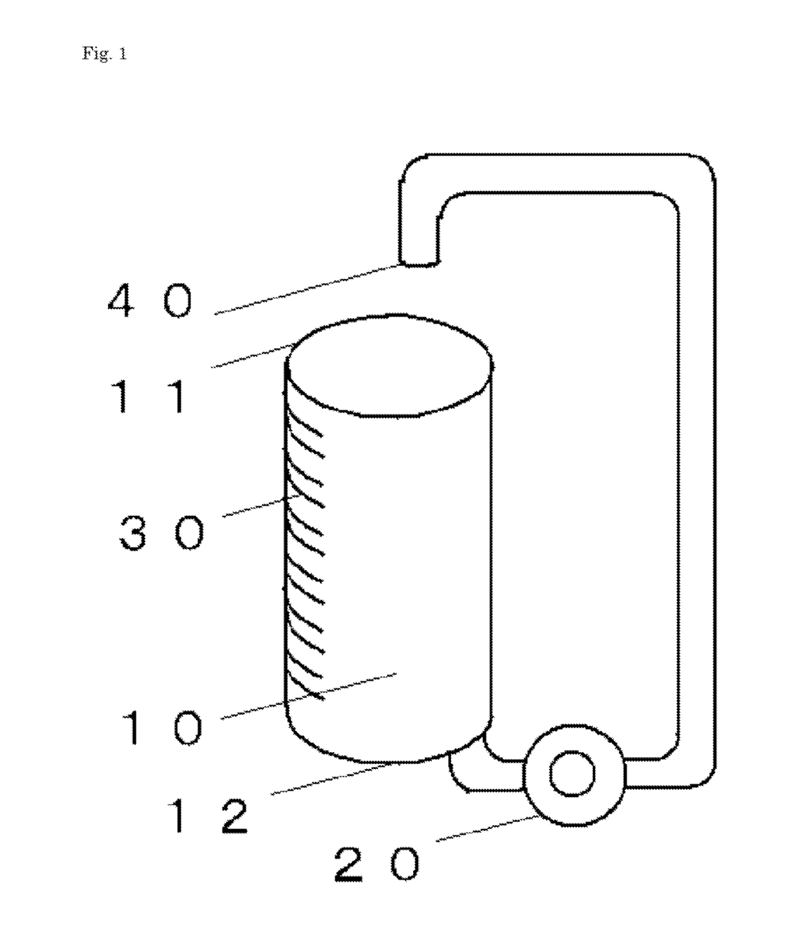

A black liquid (concentration of 15%) obtained after digestion generated in an L material kraft pulp manufacturing step (average pulp production amount: 1000 t/day) of a certain papermaking plant was adjusted to a concentration of 5% by adding tap water to prepare a defoamable test liquid. Thereafter, 500 ml of the defoamable test liquid adjusted to a temperature of 80° C. was put into a glass transparent container (10, height of 25 cm, diameter of 8 cm) of a defoaming property testing device (FIG. 1). Then, the test liquid was foamed by dropping the test liquid from the top (the height of a test liquid outlet (40) was 2 cm from an opening part (11) of the glass container) while the test liquid was circulated from a bottom part (12) of the glass transparent container by a pump (20) at 1000 ml/minute. When the foam height had reached 100 mm, 25 μl (50 ppm) of the defoaming agent (each of Examples 1 to 8 and Comparative Example 1) was added thereto, and the height (mm) of the foam surface after 1 minute and the height (mm) of the foam surface after 10 minute were read from a scale (30) (defoaming persistence). The lower the height of the foam surface, the better the defoaming persistence.

TABLE 2

Height of foam surface mm

| | | After 1 minute | After 10 minutes |
|---|---|---|---|
| Examples | 1 | 50 | 60 |
| | 2 | 30 | 35 |
| | 3 | 35 | 45 |
| | 4 | 30 | 35 |
| | 5 | 35 | 35 |
| | 6 | 30 | 35 |
| | 7 | 20 | 20 |
| | 8 | 50 | 80 |
| Comparative | 1 | 40 | — |
| Examples | | | |

In the table, “—” shows that the height exceeded 100 mm that could be measured, and the measurement was stopped.

### INDUSTRIAL APPLICABILITY

The defoaming agent of the present invention has excellent defoaming persistence, thus can be used for various applications. Particularly, it is effective for the defoaming agent of the present invention to be contained in a defoaming agent for an aqueous foamable liquid, and for example, the defoaming agent of the present invention can be applied to a defoaming agent used for air bubbles generated in various steps of paper pulp manufacturing industry (pulping step. paper-making step and painting step, etc.), construction industry (sheet making step, etc.), dyestuff industry, dyeing industry, fermentation industry, synthetic resin manufacturing industry, synthetic rubber manufacturing industry, ink and paint industry, fiber processing industry, and the like.

### DESCRIPTION OF REFERENCE SIGNS

10 Glass transparent container

11 Opening part of glass container

12 Bottom part of glass transparent

20 Pump

30 Scale

40 Test liquid outlet

1. A defoaming agent comprising:
hydrophobic silica (A) having a hydrophobicity [M value (M_{X})] of 50 to 85, and a rate of change (M_{Y}/M_{X}) of a hydrophobicity [M value (M_{Y})] after immersion for 1 hour in a methanol/ion-exchange aqueous solution (volume ratio of 80/20) of sodium hydroxide with a pH of 13 at 25° C. to the hydrophobicity [M value (M_{X})] of 0.8 to 1.0; and
at least one kind of liquid selected from the group consisting of a hydrocarbon oil (B), a non-reactive silicone oil (C) and a polyoxyalkylene compound (D).
<Measurement Method of Hydrophobicity [M values (M_{X}), (M_{Y})]>
Water/methanol mixed solutions in which methanol concentrations are changed at an interval of 2.5% by volume are prepared, and 5 ml of respective mixed solutions are put into separate 10-ml test tubes, then 0.2 g of measurement samples are put into each test tube, and the test tubes are covered, turned upside down twenty times and allowed to stand still. Thereafter, the test tubes are observed, and among mixed solutions in which aggregates are not generated and the measurement samples are all wet and uniformly mixed, a methanol concentration (% by volume) of a mixed solution with a lowest methanol concentration is defined as a hydrophobicity [M value].

2. The defoaming agent according to claim 1, wherein the hydrophobic silica is silica obtained by wet hydrophobic treatment.

3. The defoaming agent according to claim 1, farther comprising a surfactant (E).

4. The defoaming agent according to claim 1, further comprising a hydrophobic compound (F) selected from an amide, a wax and a metallic soap.

5. A method for producing latex, comprising a monomer removal step of distilling off an unreacted monomer from a latex polymerization dispersion liquid under reduced pressure, in the presence of the defoaming agent according to claim 1.

6. A method for producing a kraft pulp, comprising adding the defoaming agent according to claim 1 to a pulp slurry or a treatment liquid to produce a kraft pulp, in a digestion step, a washing step, a bleaching step, a black liquid concentrated soda recovery step and/or a waste water treatment step.
